(19) United States
(12) Patent Application Publication
(10) Pub. No.: US 2024/0410341 A1
(43) Pub. Date: Dec. 12, 2024

(54) Method For Preventing Formation Of Ice At A Blade Of A Wind Turbine

(71) Applicant: Kjell Lindskog, Skelleftea (SE)

(72) Inventor: Kjell Lindskog, Skelleftea (SE)

(21) Appl. No.: 18/698,096

(22) PCT Filed: Oct. 6, 2022
(86) PCT No.: PCT/SE2022/050895

§ 371 Date: Apr. 3, 2024

(30) Foreign Application Priority Data
Oct. 7, 2021 (SE) 2151229-8

(51) Int. Cl. F03D 80/40

(52) U.S. Cl. CPC F03D 80/401

(57) ABSTRACT

The present invention relates to a method (300) for preventing ice formation at a blade (202) of a wind turbine (200), wherein the wind turbine (200) comprises at least one first electric heating mat (102) applied to the blade (202), and wherein the method (300) includes: providing the first electric heating mat (102) with a first electric power (P1) so that the first electric heating mat (102) maintains a first operating temperature (T1), and increasing the first electric power (P1) upon an indication of icing at the blade (202). The invention also relates to an arrangement and a wind turbine comprising such an arrangement.

The present invention relates to a method for preventing ice formation at a blade of a wind turbine according to the appended patent claims. The invention also relates to an arrangement and a wind turbine comprising such an arrangement.

### BACKGROUND

Wind turbines are used to extract energy from wind. Wind energy is a renewable energy source and is part of the energy transition from fossil-based energy sources to renewable energy sources in order to achieve set climate goals. A common type of wind turbine is the one which has horizontal shafted wind turbines comprising three blades which are also called wings.

Ice formation of blades or wings can occur under certain meteorological conditions. Ice formation on blades leads to reduced efficiency and also constitutes a safety risk in case of so-called ice throw.

In order to reduce the risk of ice formation, de-icing systems are used which are usually arranged to heat up the blades and thus reduce the formation of ice on the blades.

### SUMMARY

An objective of the present invention is to provide a solution to prevent ice formation on a blade or wing of a wind turbine which has advantages over prior art.

A further objective of the present invention is to provide a solution that has good energy performance compared to known technology.

The above objectives are achieved a method for preventing ice formation at a blade of a wind turbine, wherein the wind turbine comprises at least one first electric heating mat applied to the blade, and wherein the method comprises: providing the first electric heating mat with a first electric power so that the first electric heating mat maintains a first operating temperature, and increasing the first electric power upon an indication of ice formation at the blade.

Embodiments of the method above can be found in the dependent patent claims.

The above objectives are also achieved with an arrangement for preventing ice formation at a blade of a wind turbine, wherein the arrangement comprises at least one first electric heating mat configured to be applied to the blade, a control device configured to control a supplied electric power to the first electric heating mat via a power source connected to the first electric heating mat, wherein the control device is configured to control the power source so that the power source provides the first electrical heating mat with a first electrical power so that the first electrical heating mat maintains a first operating temperature, and to increase the first electrical power upon an indication of ice formation at the blade.

Embodiments of the arrangement correspond to the embodiments of the method, for example according to the dependent patent claims attached to patent claim 1. Also, the advantages of the arrangement correspond to the advantages of the method.

The above objectives is also achieved with a wind turbine comprising: one or more blades, a generator housing to which the one or more blades are connected via a rotor hub, and an arrangement to prevent ice formation on a blade according to any embodiment of the invention. A non-limiting example of such a wind turbine is a wind turbine that has three horizontally shafted blades.

The present method, arrangement and wind turbine enable advantageous prevention of ice formation on blades or wings of wind turbines compared to known technology. By preventing ice formation, no phase transformation from ice to water is required, which results in significant energy savings. This can also be achieved without the need for operational interruptions. The present solution also enables energy savings and high efficiency in terms of, among other things, heating characteristics in different parts of the wind power plant. The method and arrangement can also be easily applied to both factory-new and commissioned blades and wind turbines.

Further advantages and embodiments of the invention will become apparent from the following detailed description.

### DESCRIPTION OF FIGURES

The following figures are intended to show embodiments of the invention in which:

FIG. 1a and 1b show an arrangement and a corresponding method according to embodiments of the invention;

FIG. 2 shows an arrangement according to an embodiment of the invention;

FIG. 3 shows an arrangement according to a further embodiment of the invention comprising a lightning conductor;

FIGS. 4 and 5 show an arrangement according to a further embodiment of the invention comprising a first heating mat placed on top of a second heating mat; and

FIG. 6 shows an arrangement according to a further embodiment of the invention including a cloud sensor.

### DETAILED DESCRIPTION

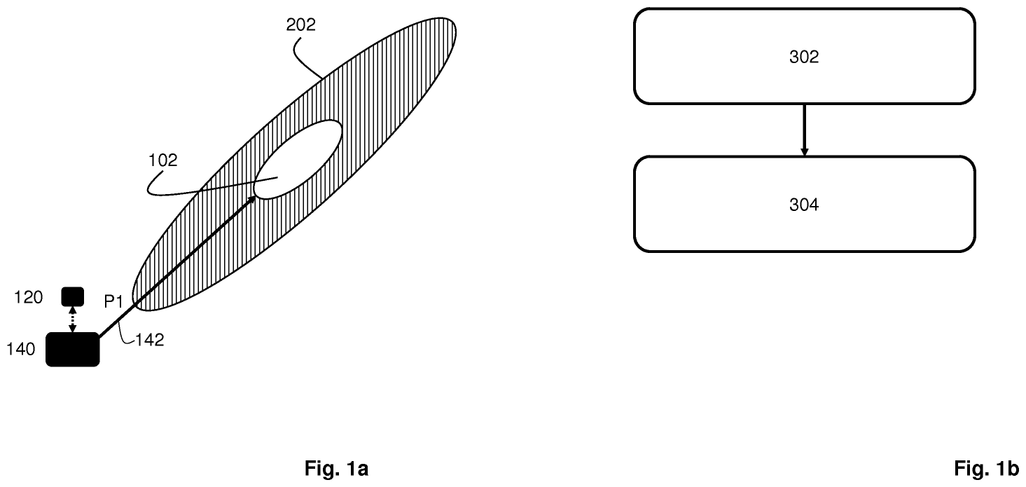

FIG. 1a shows an arrangement 100 for preventing ice formation at a blade 202 of a wind turbine 200 and FIG. 1b illustrates a corresponding method 300 for preventing ice formation at a blade 202 of a wind turbine 200 according to embodiments of the invention.

The arrangement 100 includes at least one first heating mat 102 which is arranged to be applied to a blade 202 of the wind turbine 200 to heat up the blade 202. The arrangement 100 further includes a control device 120 connected to an electric power source 140 to control the power source 140 which can be done by means of a control or communication interface. The electrical power source 140 is in turn connected to the first heating mat 102 by means of a suitable power cable 142 for providing electrical power to the first heating mat 102. The power cable can be a conductive cable of suitable dimensions. Hence, the electrical power source 140 provides the first heating mat 102 with an electrical power controlled and determined by the control device 120. The electrical power source 140 can be any suitable electrical power source providing an electrical power, for example by providing an electrical current with a certain voltage corresponding to a certain power.

The arrangement 100 for preventing ice formation at a blade 202 of a wind turbine 200 includes a control device 120 configured to control the power source 140 so that the power source 140 provides the first electric heating mat 102 with a first electric power P1, whereby the first electric heating mat 102 maintains a first operating temperature T1, and further configured to increase the first electric power P1 upon an indication of ice formation at the blade 202.

A corresponding method 300 for preventing ice formation at a blade 202 of a wind turbine 200 includes the step of providing 302 the first electric heating mat 102 with a first electric power P1 so that the first electric heating mat 102 maintains a first operating temperature T1. The method 300 further includes the step of increasing 304 the first electrical power P1 upon an indication of ice formation at the blade 202.

The first operating temperature T1 is a temperature that the first electric heating mat 102 maintains to prevent water/moisture on and near the blade 202 from turning into ice. The first operating temperature T1 is dependent on or based on one or more parameters in the group including:
An ambient temperature at the first electric heating mat 102 which affects when water freezes to ice, i.e., the phase transformation from water to ice.
An air humidity at the first heating mat 102 because the air humidity also affects the phase transformation from water to ice. The humidity at the first heating mat 102 can be given by suitable sensors placed at the first heating mat 102.
A distance d from the first electric heating mat 102 to the rotor hub 206 of the wind turbine 200 because this distance will determine the first electric heating mat's 102 highest vertical position (HVL) and lowest vertical position (LVL) and the speed at which the first electric heating mat 102 has when the blade 202 rotates in operation. The wingspan of a modern wind turbine 200 can be very large, for example 100 m with a tower height of over 250 m. This means that it matters when and where the temperature is measured at the first heating mat 102 which is correlated to where the blade 202 at which the first heating mat 102 is attached to is in its vertical height position. Particularly interesting is when the blade 202 is in its highest and lowest vertical height position as temperature, humidity, wind direction and wind strength usually differ between these extreme positions. The temperature difference between the highest and lowest vertical position can differ significantly, which affects the phase transformation. The speed also has a great influence on the phase transformation due to the so-called cooling effect. Furthermore, the wind direction can also play a not insignificant role for the phase transformation, which is affected by the location of the first electric heating mat 102 on the blade 202, which in turn is dependent on the distance d.

The first operating temperature T1 can thus be adapted to the conditions prevailing where the wind turbine 200 is located and to the location of the first heating mat on the blade 202. The first operating temperature T1 can be computed or determined by the control device 120 based on the above-mentioned one or more parameters and for example with the use of an algorithm in which these parameters are taken into account. The algorithm can be executed in a processor of the control device 120. To gain access to these parameters, the control device 120 can be connected to one or more sensors arranged at suitable positions on the wind turbine 200. In addition, the control device 120 can obtain information from databases, Internet servers, and other relevant information sources for determining the first operating temperature T1. The controller 120 can continuously compute the first operating temperature T1 and the computation periodicity can be adapted to various factors such as the speed of changes in meteorological conditions, access to relevant information, computation capacity, etc.

The control device 120 according to the invention can thus be a device comprising means for receiving sensor data and for controlling one or more heating mats, for example by means of a control algorithm. A non-limiting example is a processor or a processor arrangement with associated memory means, memory buffer, communication means, etc. The control device 120 can wirelessly and/or wired communicate with sensors and heating mats by means of, for example, standardized communication protocols. For controlling the first heating mat 102, the control device 120 can also receive and consider additional data such as meteorological data, power consumption data, operating data for the wind turbine, the power grid to which the wind turbine 200 is connected, etc. This can be done through known communication standards and protocols such as 3GPP LTE, LTE-A, 5G NR, WiFi, etc.

The first operating temperature T1 is thus a temperature at which phase transformation from water to ice is prevented from taking place as it is very energy-consuming with de-icing once ice has formed on the blade 202. Furthermore, there is a risk of ice throwing if ice has formed on the blade 202 which constitutes a safety hazard for people at the wind turbine 200 and can also cause material damage to the wind turbine 200 and surrounding objects. In other words, the present solution counteracts ice formation by keeping the first heating mat 102 at a first operating temperature T1 and by increasing the power to the first heating mat 102 when it is predicted or indicated that there is a risk of ice formation on the blade 202. Thus, ice will not form on the blade 202.

Depending on the above and possibly additional parameters, the first operating temperature T1 can be determined. According to embodiments of the invention, the first operating temperature T1 is a temperature greater than or equal to any in the range 0-10 degrees C. and preferably in the range 0-5 degrees C. That is, the first operating temperature T1 can be 0.0 degrees C., 1.0 degrees C., 1.3 degrees C., 2.0 degrees C., etc. up to 10.0 degrees C. Based the determined first operating temperature T1, the supplied power is adapted to the first electric heating mat 102 so that it keeps the first operating temperature T1 and thus the blade 202 ice free.

The present method 300 and arrangement 100 further includes monitoring and predicting ice formation at the blade 202 and, upon indication of ice formation, increasing the first electrical power P1 so that ice formation is completely prevented. Indication of ice formation at the blade 202 may be dependent on or based on one or more parameters in the group comprising:
An increase in the first electrical power P1 to maintain a first operating temperature T1, which is a clear measure because more power is needed to maintain said operating temperature T1 in case of risk of ice formation when the ambient temperature drops.
A humidity at the first heating mat 102 as described above.
An ambient temperature at the first electric heating mat 102 as described above.
A distance d from the first electric heating mat 102 to the rotor hub 206 of the wind turbine 200 as described above.
A provided power at another first heating mat 102′ arranged on the blade or on another blade of the wind turbine 200. The provided power at another first heating mat 102′ can give a good indication of the risk of ice formation also at the first heating mat 102.
An ambient temperature at another first heating mat 102′ arranged on the blade or on another blade of the wind turbine. Also the ambient temperature at another first heating mat 102′ can give a good indication of the risk of ice formation at the first heating mat 102.
A temperature at another part of the wind turbine 200, for example at the rotor hub, the nacelle, the tower 208 or at the foundation of the wind turbine 200. Also a temperature at another part of the wind turbine 200 can give a good indication of the risk of ice formation at the first heating mat 102.
An ice warning from an ice sensor 150 arranged on the blade 202, which can be considered as a direct indication of the risk of ice formation on the blade 202.

Indication of ice formation at the blade 202 can be computed, determined, predicted, estimated or detected by the control device 120 based on the above one or more parameters. The control device 120 can monitor these parameters continuously and thus detect such an indication.

To determine the indication of ice formation, one or more of the above parameters can be compared with corresponding threshold values or threshold intervals which can refer to absolute values, a change value such as a derivative, a difference, etc. A few examples are:
A change in supplied power to the first heating mat 102 in order for it to maintain the first operating temperature T1 is compared against a power threshold value.
A cloud sensor 116 indicating cloud formation and thus increased humidity, which can be compared against a threshold value for humidity.
A power increase at another first heating mat 102′ is compared against a power threshold value, which can be the same or a different power threshold compared to that of the first heating mat 102.
The temperature at another first heating mat 102′ and/or at another part of the wind turbine 200 is compared against a threshold value for temperature. Also the temperature difference between the temperature at the first heating mat 102, the temperature at another first heating mat 102′ and/or the temperature at another part of the wind turbine 200 can be compared against a threshold value for the temperature difference.

Instead of or together with threshold values, threshold intervals can also be used. A threshold interval can include several threshold values.

The method 300 and the arrangement 100 further includes increasing the first electric power P1 so that the first electric heating mat 102 maintains a higher first operating temperature than the first operating temperature T1 upon indication of ice formation at the blade 202 according to embodiments of the invention. This power increase of the first electric power P1 can be dependent on or based on one or more parameters in the group including:
An ambient temperature at the first electric heating mat 102 as described above.
A humidity at the first heating mat 102 as described above.
A distance d from the first electric heating mat 102 to the rotor hub 206 of the wind turbine 200 as described above.

The determination or computation of the power increase of the first electrical power P1 can be computed/determined by the control device 120 based on the above one or more parameters. After computing the power increase, the control device 120 can control the power source 140 so that this power is supplied to the first heating mat 102.

Correspondingly, the control device 120 can also be arranged to reduce the first electrical power P1 after a power increase if it is indicated that there is no longer a risk of ice formation. This can be done by the control device 120 taking into account the above parameters which, however, can be compared against other threshold values and/or threshold intervals for a power reduction and thus a reduction of the first operating temperature T1. For example, the power can be lowered so that the first heating mat 102 maintains the original first operating temperature T1 or another first operating temperature T1 depending on the parameters specified above.

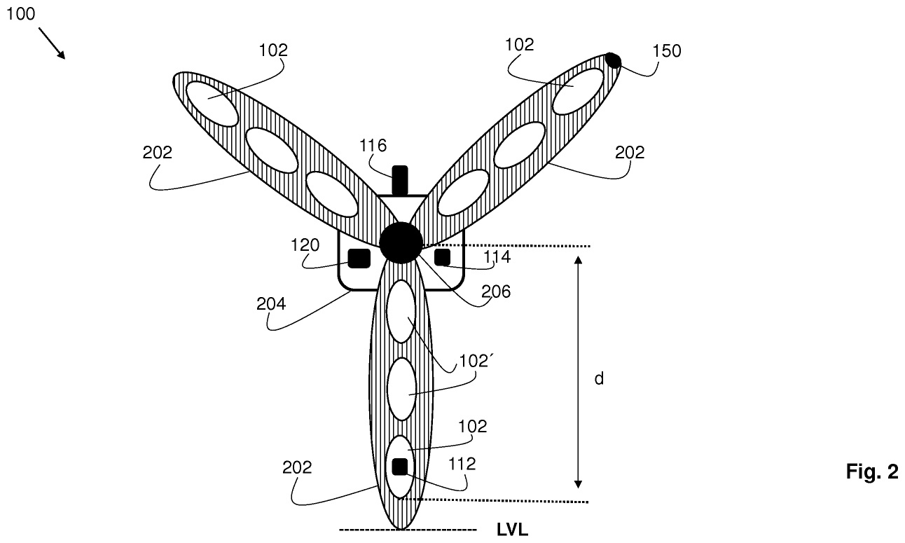

FIG. 2 shows an arrangement 100 for preventing ice formation on a blade 202 of a wind turbine 200 according to a further embodiment of the invention. According to this embodiment, the arrangement 100 comprises a plurality of separate first heating mats 102, 102′ which are arranged to be placed on a blade 202 of the wind turbine 200 in order to heat up the blade 202. It is thus realised that the present arrangement 100 can comprise a number of first heating mats 102 deployed on appropriate parts of the blade 202 and controlled and monitored by the control device 120. In other words, the wind turbine 200 comprises a plurality of separate first electric heating mats 102, 102′ placed along the extension of the blade 202 from the rotor hub 206 to the top of the blade 202 according to embodiments of the invention.

Some first heating mats 102 can be used both as temperature sensors and heat generators, while other first heating mats function only as heat generators. However, a first heating mat 102 can function as temperature sensor and heat generator on each blade 202 according to embodiments of the invention. A first heating mat 102 which also functions as a temperature sensor can, according to an embodiment, be placed on the tip of the blade, i.e., at the far end of the blade 202 to obtain the largest temperature difference for a first heating mat 102 between its highest and lowest vertical position. The tip of the blade is also a suitable location for an ice sensor 150 as shown in FIG. 2.

A further function of a first heating mat 102 is that it can indicate damage to the heating mat itself, i.e., act as a damage sensor. If the heating mat is damaged, the electrical circuit in the heating mat is broken, which is detected by the control device 120, which can take appropriate action. For example, if the placement of heating mats is the same on the wind turbine's 200 different blades, the control device 120, if it detects damage to a heating mat placed on a blade, can turn off heating mats with corresponding placement on those blades. This results in a symmetrical heat dissipation on the different blades, which results in balanced operation.

In summary, a first heating mat 102 according to the invention can include one to four different functions with the same basic construction or design depending on the application, namely: act as a heat generator to prevent ice formation; act as a temperature sensor by impedance measurement/resistance measurement in the circuit when sending current pulses; act as a damage sensor by detecting a break in one of its circuits; and act as an ice sensor. In the latter case, the first heating mat 102 is placed directly on the blade 202 without any other intermediate second heating mat (see below) and if a temperature difference between the temperature at the first heating mat 102 and a reference temperature at another part of the wind turbine 200 is greater than a threshold value indication of risk for ice formation on the blade 202, i.e., an ice sensor.

The two latter functions can be combined by sending out a first type of current pulse with suitable duration and periodicity suitable for temperature indication and damage status. The first type of current pulse can be combined with sending out a second type of current pulse with a different duration and periodicity suitable for the heat generation of the heating mat. The first type of current pulse can, for example, have a shorter duration and a higher periodicity compared to the second type of current pulse, or vice versa. The four functions mentioned above can be activated and deactivated for different heating mats individually or in groups, which means great flexibility and adaptability of the arrangement 100 for different meteorological conditions and different operating situations for the wind turbine 200.

The arrangement 100 can further include a plurality of first temperature sensors 112 arranged to provide a temperature at the first heating mats 102, 102′ and further a second temperature sensor 114 arranged to provide a reference temperature at a generator housing/nacelle 204 of the wind turbine 200. The control device 120 is connected to the first temperature sensors 112 and the second temperature sensor 114 to obtain information about the temperatures.

A first temperature sensor 112 can be arranged on or near a first heating mat 102 as shown in FIG. 2. According to an embodiment of the invention, the first temperature sensor 112 is integrated with the first heating mat 102 as described above and can be implemented as a power consumption sensor or a current consumption sensor which measures the consumption in the first heating mat 102. By measuring or determining how much power or current that is consumed in the first heating mat 102, the temperature at the first heating mat 102 can also be obtained. This can be done by using current pulses in combination with impedance measurement of the current pulses in the power cables 142.

In order to generate and regulate the heat in the first heating mat 102, an electric current can be guided in a conductive material in the heating mat. Various current pulse patterns can then be used to control the degree of heating of the first heating mat 102. It is further understood that each section of a heating mat can be individually controllable with, for example current pulses, which among other things enables a variable degree of heating along the actual rotor blade 202, for example through recessed cable routing.

Similarly, the second temperature sensor 114 can be arranged on or near the generator housing 204 as shown in FIG. 2 but is not limited to this location. The second temperature sensor 114 can be a temperature sensor according to known technology and functions as a reference temperature sensor. Said generator housing 204 includes or encloses the wind turbine's generator to generate electrical energy and is thus connected to the blades via a generator hub/rotor hub 206.

The plurality of first heating mats 102, 102′ can be controlled coordinated or individually depending on the application. Furthermore, the value of the first operating temperature T1 and/or the increase of the power can be coordinated or controlled individually. This also means that the operating temperature T1 and/or the increase in power can be the same or different for the plurality of first heating mats. In the case that the operating temperature T1 and/or the increase in power are different, an example is that the operating temperature T1 and/or the increase in power increases with the distance d. Indication of ice formation at the blade 202 can also differ between the different first heating mats 102, 102′. The plurality of first heating mats 102, 102′ can be interconnected with common power cables 142 or have individual power cables 142.

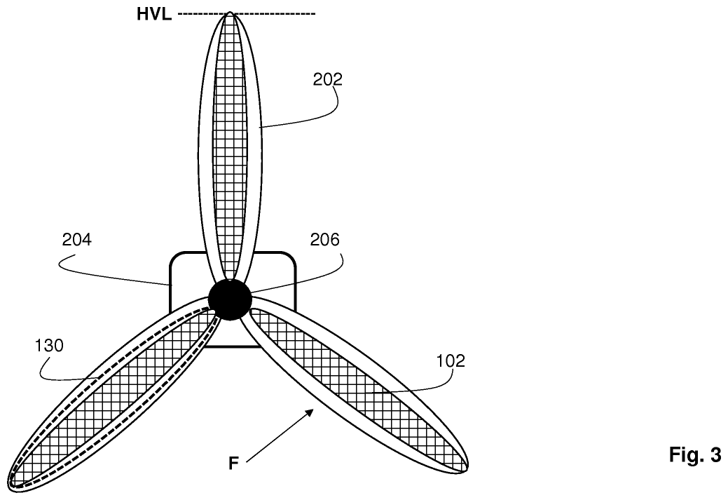

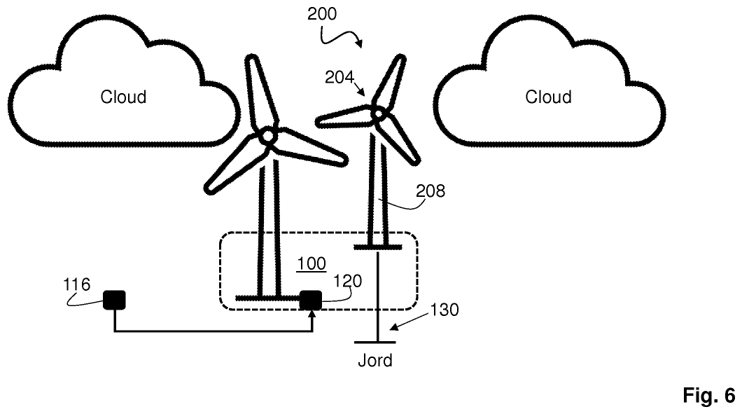

FIG. 3 shows an arrangement 100 according to a further embodiment of the invention, i.e., including a lightning conductor 130. As shown in FIG. 3, the lightning conductor 130 completely encloses the first heating mat 102 from the tip/top of the blade 202 and along the extension of the blade to the rotor hub 206. With the placement of the lightning conductor 130 outside and surrounding the first heating mat 102, it is protected from damage at lightning strikes in the wind power plant 200. The lightning conductor 130 is connected via suitable conductive lines to ground for the down-conduction of lightning strikes which is shown in FIG. 6. It is also understood that each blade 202 may include a lightning conductor but only one lightning conductor 130 is shown in FIG. 3.

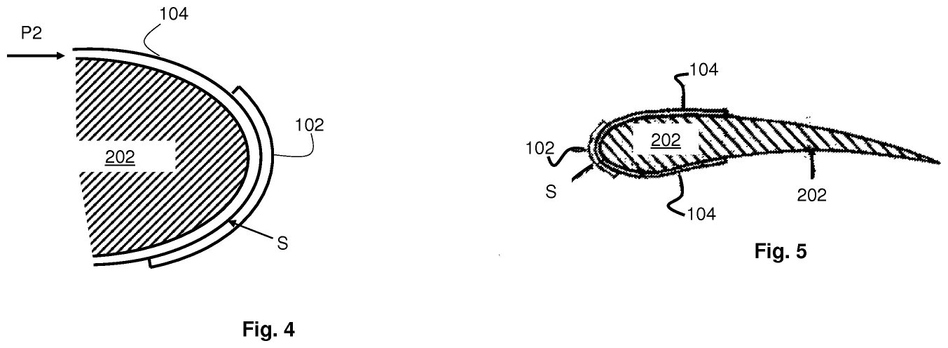

Furthermore, it can be seen from FIG. 3 that the first heating mat 102 according to an embodiment is arranged to be applied to the rotational front part F of the blade 202 since the risk of ice formation is greatest on this part of the blade 202. This applies in particular to the part of the front part of the blade or wing 202 which is called stagnation point S which is shown in FIGS. 4 and 5. Thus, the first heating mat 102 is applied to cover the stagnation point S of the blade 202 directly on the blade 202 as in FIG. 3 or indirectly on the blade 202 via one or more other heating mats 104 as shown in FIGS. 4 and 5 according to embodiments of the invention.

FIGS. 4 and 5 show an arrangement 100 where a second heating mat 104 also is included and where the first heating mat 102 is placed on top of the second heating mat 104. In other words, the arrangement 100 includes at least one second heating mat 104 which is arranged to be placed on the blade 202 under the first heating mat 102 and further arranged to heat up the blade 202. To this end, the first heating mat 102 and/or the second heating mat 104 may include specific attachment means (not shown in the figures) for attaching the first heating mat 102 directly to the second heating mat 104 without intermediate insulating layers or layers between them as is customary. The second heating mat 104 also functions as insulation for the blade 202, which means that the heat generation of the first overlying heating mat 102 is directed away from the blade 202 and thus leads to improved prevention of ice formation.

In addition, to provide a more energy efficient solution, the second heating mat 104 coverage area on blade 202 may be larger than the first heating mat 102 coverage area on blade 202, as also shown in FIGS. 4 and 5. By only partially applying first heating mats 102 to, for ice formation especially exposed leaf surfaces, the arrangement's 100 energy consumption can be kept down substantially.

According to an embodiment of the invention, the wind turbine 200 comprises at least two other electric heating mats 104, 104′ which are attached to the blade 202 next to each other along an interface and the first electric heating mat 102 at least partially covers the interface. Said interface can be a so-called “center leading edge” of the blade 202. Furthermore, a second electric heating mat 104 can be placed on the suction side of the blade 202 and another second electric heating mat 104′ can be placed on the pressure side of the blade 202. The area of the second electric heating mat 104 which is placed on the suction side of the blade is larger than the area of the second electric heating mat 104 which is placed on the pressure side of the blade 202 according to embodiments of the invention.

According to further embodiments of the invention, the second electric heating mat 104 is provided with a second electric power P2 so that the second electric heating mat 104 maintains a second operating temperature T2. The second operating temperature T2 can be compared to the first operating temperature T1 and be equal to or lower than the first operating temperature T1 according to embodiments of the invention.

As with the first heating mat 102, the second electrical power P2 is increased upon indication of ice formation at the blade 202. The increase of the second electrical power P2 is such that the second electrical heating mat 104 maintains a second higher operating temperature than the second operating temperature T2 upon indication of ice formation at the blade 202. Also the second electrical power P1 can be provided by means of current pulses which can have a characteristic as previously described. The first electric power P1 and the second electric power P2 can be controlled and increased synchronously for improved effect in preventing ice formation on the blade 202. It is further noted that a second heating mat 104 can be configured with three of the functions that a first heating mat 102 can have, namely, to act as a heat generator, a temperature sensor, and a damage sensor.

FIG. 6 shows an arrangement 100 including a cloud sensor 116 for detecting or indicating clouds or cloud formation at the wind turbine 200. It has previously been established that in the presence of clouds and cloud formation at the blades 202, the risk of ice formation on the blades increases due to the increased air humidity. This ice formation can then also take place at lower temperatures than what is established. The cloud sensor 116 may, as shown in FIG. 6, be located outside the wind turbine 200 or as shown in FIG. 2 on or at the generator house 204. The arrangement 100 may include one or more cloud sensors connected to the control device 120 and data or information from these are coordinated for improved prediction or actual indication of clouds at the blade 202. Various different techniques can be applied for cloud detection and one example is radar technology where radio waves are emitted and reflected radar waves are analysed to determine the presence of clouds at the blade/wind turbine.

The lightning conductor's 130 earth point, i.e., the point where the lightning is led down to earth is also shown in FIG. 6. It should further be noted that the previously mentioned lightning conductor 130 can also completely enclose the second heating mat 104 from the tip of the blade and along the extension of the blade, which is however not shown in the figures. This means that the second heating mat 104 is also protected in the event of a lightning strike.

It is further noted from FIG. 6 that the control device 120 can be located at the foundation of the wind turbine and is thus not limited to being located in the nacelle. The control device 120 may be implemented as a centralized system or a distributed system. In the latter case, part or the entire system can be remotely located in relation to the wind turbine 200, for example in a central control centre which can control and serve a large number of wind turbines.

Regarding the general construction and design of the first 102 and second 104 electric heating mats, the following may also be noted. A first 102 or second 104 electric heating mat can be made up of an electrically conductive wire, for example of copper, which exhibits an electrically insulating surface layer so that a touching wire crossing is possible without risk of short circuit. Instead of the insulating wire, an insulated band or the like can be used. The heating mat can also be produced through a knitting operation and the shape, size and pattern of the heating mat can be varied according to needs and wishes. For example, varnish insulated copper wire within a diameter range of approx. 0.1-1.5 mm and a mesh size of approx. 1-30 mm can be used. The desired performance of the heating mat affects the choice of wire diameter and mesh size, and if the heating mat is of single wire, this results in a single electrical circuit. If, on the other hand, the heating mat is knitted from double thread, two electrical current circuits are possible, etc. A heating mat can also contain several sub-mats of different types.

The heating mat can also be produced by a crocheting operation or other wire laying using electrically conductive wire or band which exhibits an electrically insulating surface layer so that an adjacent wire crossing or tape crossing is possible without risk of short circuit. If wire crossing is avoided, the wire/ribbon may in some cases be uninsulated. The heating mat's size, shape and wire or band pattern can be varied according to needs and wishes. The same prerequisites as for the pattern variant described above are applicable in terms of wire selection, band selection, wire laying, etc. If the heating mat is made of double wire or double band, two power circuits are possible. Alternatively, one of the current circuits can be used as a backup circuit in the event of a wire or band break as discussed above.

A heating mat can include one or more sub-mats of incompletely cured thermoplastic that can be reinforced with suitable reinforcement material. The thermoplastic can for example be polyester, epoxy plastic or polyurethane and any reinforcement can for example be glass fibre or carbon fibre. The incompletely cured partial mat provides an adhesion of the heating mat so that they form a cohesive unit with a mouldability/bendability which means that it can be stored and transported rolled or folded.

Finally, it should be understood that the present invention is not limited to the embodiments described above, but includes and relates to all embodiments within the scope of protection of the independent patent claims.

1. A method (300) for preventing ice formation at a blade (202) of a wind turbine (200), wherein the wind turbine (200) comprises at least one first electric heating mat (102) applied to the blade (202), and wherein the method (300) comprises: providing the first electric heating mat (102) with a first electric power (P1) so that the first electric heating mat (102) maintains a first operating temperature (T1), and increasing the first electric power (P1) upon an indication of ice formation at the blade (202).

2. The method (300) according to claim 1, wherein the method (300) comprises increasing the first electrical power (P1) so that the first electrical heating mat (102) maintains a higher first operating temperature than the first operating temperature (T1) upon indication of ice formation by the blade (202)

3. The method (300) according to claim 1, wherein the increase in the first electric power (P1) is dependent on or based on one or more parameters in the group comprising: an ambient temperature at the first electric heating mat (102), an air humidity at the first heating mat (102), and a distance (d) from the first electric heating mat (102) to the rotor hub (206) of the wind turbine (200).

4. The method (300) according to claim 1, wherein indication of ice formation at the blade (202) is dependent on or based on one or more parameters in the group comprising: an increase in the first electrical power (P1), an air humidity at the first heating mat (102), an ambient temperature at the first electric heating mat (102), a distance (d) from the first electric heating mat (102) to the rotor hub (206) of the wind turbine (200), a provided power at another first heating mat (102′), an ambient temperature at another first heating mat (102′), a temperature at another part of the wind turbine (200), and an ice warning from an ice sensor (102, 150) arranged on the blade (202).

5. The method (300) according to claim 4, wherein indication of ice formation at the blade (202) is dependent on or based on comparing the one or more parameters with corresponding threshold values or threshold intervals.

6. The method (300) according to claim 1, wherein the first operating temperature (T1) is dependent on or based on one or more parameters in the group comprising: an ambient temperature at the first electric heating mat (102), an air humidity at the first the heating mat (102), and a distance (d) from the first electric heating mat (102) to the rotor hub (206) of the wind turbine (200).

7. The method (300) according to claim 1, wherein the first operating temperature (T1) is greater than or equal to any temperature in the range 0-10 and preferably any temperature in the range 0-5 degrees C.

8. The method (300) according to claim 1, wherein the first electric heating mat (102) is applied to the rotational front part (F) of the blade (202) and covers the stagnation point (S) of the blade (202).

9. The method (300) according to claim 1, wherein the wind turbine (200) comprises a plurality of separate first electric heating mats (102, 102′) placed along the extension of the blade (202) from the rotor hub (206) to the top of the blade (202).

10. The method (300) according to claim 1, wherein the wind turbine (200) comprises at least one second electric heating mat (104) applied to the blade (202) between the first electric heating mat (102) and the blade (202), and wherein an area of the second electric heating mat (104) is greater than an area of the first electric heating mat (102).

11. The method (300) according to claim 10, wherein the method (300) comprises providing the second electric heating mat (104) with a second electric power (P2) so that the second electric heating mat (104) maintains a second operating temperature (T2).

12. The method (300) according to claim 11, wherein the second operating temperature (T2) is equal to or lower than the first operating temperature (T1).

13. The method (300) according to claim 11, wherein the method (300) comprises increasing the second electric power (P2) upon indication of ice formation at the blade (202).

14. The method (300) according to claim 13, wherein the method (300) comprises increasing the second electric power (P2) so that the second electric heating mat (104) maintains a second higher operating temperature than the second operating temperature (T2) upon indication of ice formation at the blade (202).

15. The method (300) according to claim 13, wherein the method (300) comprises increasing the first electric power (P1) and the second electric power (P2) synchronously.

16. The method (300) according to claim 10, wherein the wind turbine (200) comprises at least two second electric heating mats (104, 104′) applied to the blade (202) adjacent to each other along an interface, wherein the first electric heating mat (102) at least partially overlaps the interface.

17. The method (300) according to claim 11, wherein the first electric power (P1) and/or the second electrical power (P2) is provided by means of current pulses.

18. An arrangement (100) for preventing ice formation at a blade (202) of a wind turbine (200), wherein the arrangement (100) comprises at least one first electric heating mat (102) configured to be applied to the blade (202), a control device (120) configured to control electric power supplied to the first electric heating mat (102) via a power source (140) connected to the first electric heating mat (102), wherein the control device (120) is configured to control the power source (140) so that the power source (140) provides the first electric heating mat (102) with a first electrical power (P1) so that the first electric heating mat (102) maintains a first operating temperature (T1), and to increase the first electrical power (P1) upon an indication of ice formation at the blade (202).

19. The method (300) according to claim 2, wherein the increase in the first electric power (P1) is dependent on or based on one or more parameters in the group comprising: an ambient temperature at the first electric heating mat (102), an air humidity at the first heating mat (102), and a distance (d) from the first electric heating mat (102) to the rotor hub (206) of the wind turbine (200).

20. The method (300) according to claim 12, wherein the method (300) comprises increasing the second electric power (P2) upon indication of ice formation at the blade (202).
